(19) United States
(12) Patent Application Publication
(10) Pub. No.: US 2014/0214963 A1
(43) Pub. Date: Jul. 31, 2014

(54) METHOD, SERVER AND SYSTEM FOR DATA SHARING IN SOCIAL NETWORKING SERVICE

(71) Applicant: TENCENT TECHNOLOGY (SHENZHEN) COMPANY LIMITED, Shenzhen City (CN)

(72) Inventors: Yipeng Zhao, Shenzhen City (CN); Xiaocong Huang, Shenzhen City (CN)

(73) Assignee: TENCENT TECHNOLOGY (SHENZHEN) COMPANY LIMITED, Shenzhen City (CN)

(21) Appl. No.: 14/230,408

(22) Filed: Mar. 31, 2014

Related U.S. Application Data
(63) Continuation of application No. PCT/CN2013/088016, filed on Nov. 28, 2013.

(30) Foreign Application Priority Data
Dec. 14, 2012 (CN) 2012105435551

(51) Int. Cl. H04L 29/06

(52) U.S. Cl. CPC H04L 65/403
USPC 709/204

(57) ABSTRACT

Embodiments of the present invention provide method, server and system for data sharing in a social networking service (SNS), and non-transitory computer-readable medium storing instructions which, when executed by one or more processors, cause the system to perform the method for data sharing the SNS. The method includes upon detecting that an account is logged into through a first terminal, establishing a connection of communications to the first terminal; if the account is currently logged into from multiple points, associating an address identifier of the first terminal with an address identifier of at least one second terminal logging into the account, so as to obtain mapping relationship information; and according to the mapping relationship information, forwarding received data of the first terminal to the at least one second terminal, and forwarding received data of the at least one second terminal to the first terminal.

### CROSS-REFERENCE TO RELATED APPLICATION

This application is a continuation application of International Patent Application No. PCT/CN2013/088016, filed Nov. 28, 2013, which itself claims the priority to Chinese Patent Application No. 201210543555.1, filed Dec. 14, 2012 in the State Intellectual Property Office of P.R. China, which are hereby incorporated herein in their entireties by reference.

### FIELD OF THE INVENTION

The present invention generally relates to the field of computers, and more particularly to a method, a server and a system for data sharing in a social networking service (SNS), and a non-transitory computer-readable medium storing instructions which, when executed by one or more processors, cause the system to perform the method for data sharing the SNS.

### BACKGROUND OF THE INVENTION

Currently, a great deal of communication applications is implemented by using the Internet, computer terminals such as personal computers (PCs), and smart mobile terminals. Especially, social networking service (SNS) applications are dramatically developed and popularized, for example, micro-blogging, space album, data sharing, and blogging. A user installs an application in a terminal such as a PC or a mobile phone device, and inputs a corresponding personal account, so as to send or broadcast various messages to other users, whereby communications of people are not limited to a communication network.

When a user uses a corresponding communication application in a mobile terminal or in a PC, there often is a need to transfer communications data obtained by a mobile terminal into a PC, for example, to transfer a photo into the PC, so as to have a better view of the photo through a big screen of the PC; or to transfer data from the PC into a mobile terminal such as a mobile phone, e.g., to transfer business card information in the PC to the mobile terminal, so as to be viewed anytime through portability of the mobile terminal when needed.

In the existing technology of data sharing between terminals, a data line is usually used for connection to transmit data. However, if a user does not have the data line at the moment, data sharing cannot be achieved. On the other hand, the user may manually input, for example, business card information to realize data transfer, but manual input is error-prone and time-consuming.

Therefore, a heretofore unaddressed need exists in the art to address the aforementioned deficiencies and inadequacies.

### SUMMARY OF THE INVENTION

Embodiments of the present invention provide method, server and system for data sharing in an SNS, and non-transitory computer-readable medium storing instructions which, when executed by one or more processors, cause the system to perform the method for data sharing the SNS, so as to share data between different terminals based on an account of a communication application.

In one aspect, the present invention relates to a method for data sharing in an SNS. In one embodiment, the method includes upon detecting that an account is logged into through a first terminal, establishing a connection of communications to the first terminal; if the account is currently logged into from multiple points, associating an address identifier of the first terminal with an address identifier of at least one second terminal logging into the account, so as to obtain mapping relationship information; and according to the mapping relationship information, forwarding received data of the first terminal to the at least one second terminal, and forwarding received data of the at least one second terminal to the first terminal.

In one embodiment, before the step of upon detecting that the account is logged into through the first terminal, establishing the connection of communications to the first terminal, the method further includes upon detecting that the account is logged into through the at least one second terminal, establishing a connection of communications to the at least one second terminal, and recording the address identifier of the at least one second terminal.

In one embodiment, the step of establishing the connection of communications to the first terminal includes establishing a long connection to the first terminal that logs into the account. The step of establishing the connection of communications to the at least one second terminal includes establishing a long connection to the at least one second terminal that logs into the account.

In one embodiment, the step of according to the mapping relationship information, forwarding the received data of the first terminal to the at least one second terminal, and forwarding the received data of the at least one second terminal to the first terminal includes upon receiving the data sent through the account by the first terminal, searching, according to the mapping relationship information, for address information of the at least one second terminal associated with the first terminal under the account, and forwarding, according to the address information, the data, sent by the first terminal, to the at least one second terminal; and upon receiving the data sent through the account by the at least one second terminal, searching, according to the mapping relationship information, for address information of the first terminal associated with the at least one second terminal under the account, and forwarding, according to the address information, the data, sent by the at least one second terminal, to the first terminal.

In one embodiment, the step of according to the mapping relationship information, forwarding the received data of the first terminal to the at least one second terminal, and forwarding the received data of the at least one second terminal to the first terminal includes upon receiving operation instruction data of the first terminal for the communication application corresponding to the account, searching, according to the mapping relationship information, for address information of the at least one second terminal associated with the first terminal under the account, and forwarding, according to the address information, the operation instruction data, sent by the first terminal, to the at least one second terminal, so that the at least one second terminal performs a synchronous operation on the communication application corresponding to the account according to the operation instruction data; and upon receiving operation instruction data of the at least one second terminal for the communication application corresponding to the account, searching, according to the mapping relationship information, for address information of the first terminal associated with the at least one second terminal under the account, and forwarding, according to the address information, the operation instruction data, sent by the at least one second terminal, to the first terminal, so that the first terminal performs a synchronous operation on the communication application corresponding to the account according to the operation instruction data.

In one embodiment, the account includes an account of an SNS application.

In another aspect, the present invention relates to a server for date sharing. In one embodiment, the server includes a connection establishing module, configured to, upon detecting that an account is logged into through a first terminal, establish a connection of communications to the first terminal; a processing module, configured to, if the account is currently logged into from multiple points, associate an address identifier of the first terminal with an address identifier of at least one second terminal logging into the account, so as to obtain mapping relationship information; and a forwarding module, configured to, according to the mapping relationship information, forward received data of the first terminal to the at least one second terminal, and forward received data of the at least one second terminal to the first terminal.

In one embodiment, the server further includes a recording module. The connection establishing module is further configured to upon detecting that the account is logged into through at least one second terminal, establish a connection of communications to the at least one second terminal. The recording module is configured to record the address identifier of the at least one second terminal.

In one embodiment, the connection establishing module is specifically configured to establish long connections to the first terminal and the at least one second terminal.

In one embodiment, the forwarding module includes a first receiving unit, configured to receive data sent through the account by the first terminal; a first forwarding unit, configured to, according to the mapping relationship information, search for address information of at least one second terminal associated with the first terminal under the account, and according to the address information, send the data, received by the first receiving unit, to at least one second terminal; a second receiving unit, configured to receive data sent through the account by the at least one second terminal; and a second forwarding unit, configured to, according to the mapping relationship information, search for address information of the first terminal associated with the at least one second terminal under the account, and according to the address information, send the data, received by the second receiving unit, to the first terminal.

In one embodiment, the forwarding module further includes a third receiving unit, configured to receive operation instruction data of the first terminal for the communication application corresponding to the account; a third forwarding unit, configured to, according to the mapping relationship information, search for address information of at least one second terminal associated with the first terminal under the account, and according to the address information, send the operation instruction data, received by the third receiving unit, to at least one second terminal, so that the at least one second terminal performs a synchronous operation on the communication application corresponding to the account according to the operation instruction data; a fourth receiving unit, configured to receive operation instruction data of the at least one second terminal for the communication application corresponding to the account; and a fourth forwarding unit, configured to, according to the mapping relationship information, search for address information of the first terminal associated with the at least one second terminal under the account, and according to the address information, send the operation instruction data, received by the fourth receiving unit, to the first terminal, so that the first terminal performs a synchronous operation on the communication application corresponding to the account according to the operation instruction data.

In yet another aspect, the present invention further relates to a system for data sharing in an SNS, which in one embodiment includes a server, a first terminal, and at least one second terminal.

The first terminal is configured to log into the server through an account.

The server is configured to upon detecting that the account is logged into through the first terminal, establish a connection of communications to the first terminal, and is configured to when the account is currently logged into from multiple points, associate an address identifier of the first terminal with an address identifier of at least one second terminal logging into the account, so as to obtain mapping relationship information;

Additionally, the first terminal is further configured to send data to the server, where the data includes communications data or operation instruction data for the communication application which is sent through the server to the at least one second terminal;

The at least one second terminal is configured to send data to the server, where the data includes communications data or operation instruction data for the communication application which is sent through the server to the first terminal; and

The server is further configured to according to the mapping relationship information, forward received data of the first terminal to the at least one second terminal, and forward received data of the at least one second terminal to the first terminal.

In one embodiment, the server includes an SNS application server.

In a further aspect, the present invention, the present invention relates to a non-transitory computer-readable medium storing instructions which, when executed by one or more processors, cause the above system to perform the above method for data sharing in the SNS.

Implementation of the embodiments of the present invention has the following beneficial effects. According to the present invention, data sharing between different terminal devices can be achieved according to a communication application account, no data line or manual operation of a user is needed, a function of a communication application is added, and the user may perform operation according to corresponding data by reasonably making use of advantages of different terminals.

These and other aspects of the present invention will become apparent from the following description of the preferred embodiment taken in conjunction with the following drawings, although variations and modifications therein is affected without departing from the spirit and scope of the novel concepts of the present invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment. The drawings do not limit the present invention to the specific embodiments disclosed and described herein. The drawings are not necessarily to scale, emphasis instead being placed upon clearly illustrating the principles of the invention.

FIG. 1 is a schematic flow chart of a method for data sharing in an SNS according to one embodiment of the present invention.

FIG. 2 is a schematic flow chart of a method for data sharing in an SNS according to another embodiment of the present invention.

FIG. 3 is a schematic flow chart of a first embodiment of a data forwarding method of the present invention.

FIG. 4 is a schematic flow chart of a second embodiment of a data forwarding method of the present invention.

FIG. 5 is a schematic structural diagram of a system for data sharing in an SNS according to an embodiment of the present invention.

FIG. 6 is a schematic structural view of a server according to an embodiment of the present invention.

FIG. 7 is a schematic view of a specific structure of a forwarding module of the server shown in FIG. 6.

FIG. 8 is a schematic view of another specific structure of the forwarding module of the server shown in FIG. 6.

### DETAILED DESCRIPTION OF THE INVENTION

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are configured to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method is executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules is executed using a single (shared) processor. In addition, some or all code from multiple modules is stored by a single (shared) memory. The term “group”, as used herein, means that some or all code from a single module is executed using a group of processors. In addition, some or all code from a single module is stored using a group of memories.

The systems and methods described herein are implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

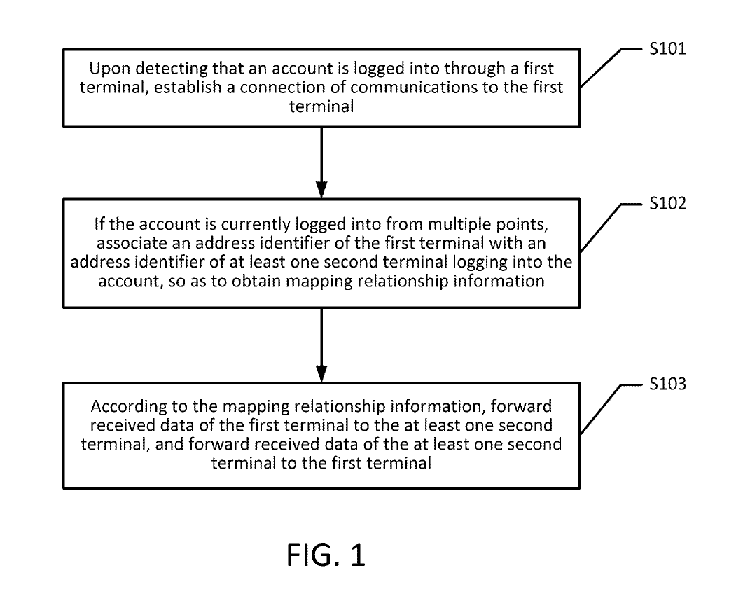

The description will be made as to the embodiments of the present invention in conjunction with the accompanying drawings in FIGS. 1-8. It should be understood that specific embodiments described herein are merely intended to explain the present invention, but not intended to limit the present invention. In accordance with the purposes of this invention, as embodied and broadly described herein, this invention, in one aspect, relates to method, server and system for data sharing in an SNS, and a non-transitory computer-readable medium storing instructions which, when executed by one or more processors, cause the system to perform the method for data sharing in the SNS.

Referring to FIG. 1, a flow chart of a method for data sharing in an SNS is shown according to an embodiment of the present invention. The method can be applied in various SNS application servers. With a communication application account, or an Attorney Docket No.: 22248-98156 account hereinafter for short, obtained by applying, a user may perform data sharing between devices of the user, such as a PC and a mobile terminal, according to the account. Specifically, the method includes the following steps.

Step S101: Upon detecting that an account is logged into through a first terminal, establish a connection of communications to the first terminal.

The first terminal is a mobile terminal, such as a mobile phone and a tablet computer, or a fixed terminal such as a PC, which is installed with a corresponding communication application.

A user opens the communication application on the first terminal, and logs into a server of the communication application according to the account that is already applied for. After account authentication succeeds, the server of the communication application accesses the first terminal, and the user logs in successfully. The server may establish the connection of communications to the first terminal, which is a long connection, so as to perform data sharing anytime. As used herein, the term “long connection” refers to a communication connection technology between a server and a terminal. After the long connection is established, the server and the terminal keep communication at any time, and a communication connection does not need to be established again. The long connection belongs to bi-directional connection, the terminal may send data to the server through the long connection, and the server may also send data to the terminal through the long connection.

Step S102: If the account is currently logged into from multiple points, associate an address identifier of the first terminal with an address identifier of at least one second terminal logging into the account, so as to obtain mapping relationship information.

The server searches for information of all other terminals, which currently already log into the account, according to the account. If at least one other terminal, that is, at least one second terminal is further included besides the first terminal, it indicates that a current login status of the account is a multiple-points-of-presence status.

Associating the address identifier of the first terminal with the address identifiers of all the second terminals may specifically be that a mapping table with the account being a topic identifier stores the address identifier of the first terminal and the address identifiers of all the second terminals, so as to obtain the mapping relationship information, where the address identifier can be a phone number of a mobile terminal such as a mobile phone and an IP address of a terminal such as a PC.

Step S103: According to the mapping relationship information, forward received data of the first terminal to the at least one second terminal, and forward received data of the at least one second terminal to the first terminal.

When the user sends data through the communication application on the first terminal, corresponding account information and the address identifier of the first terminal can be carried to be sent to the server, and the server may first find the corresponding account according to the account information, and then send the data to all the second terminals according to the mapping relationship information and according to the other address identifiers except the address identifier carried in the data. Similarly, when any terminal among all the second terminals sends data, the account and the address identifier are also carried, so that the server forwards the data of the terminal to all the other terminals including the first terminal.

According to this embodiment of the present invention, data sharing between different terminal devices can be realized according to an account, no data line or manual operation of a user is needed, a function of the communication application is added, and the user may perform operation according to corresponding data by reasonably making use of advantages of different terminals.

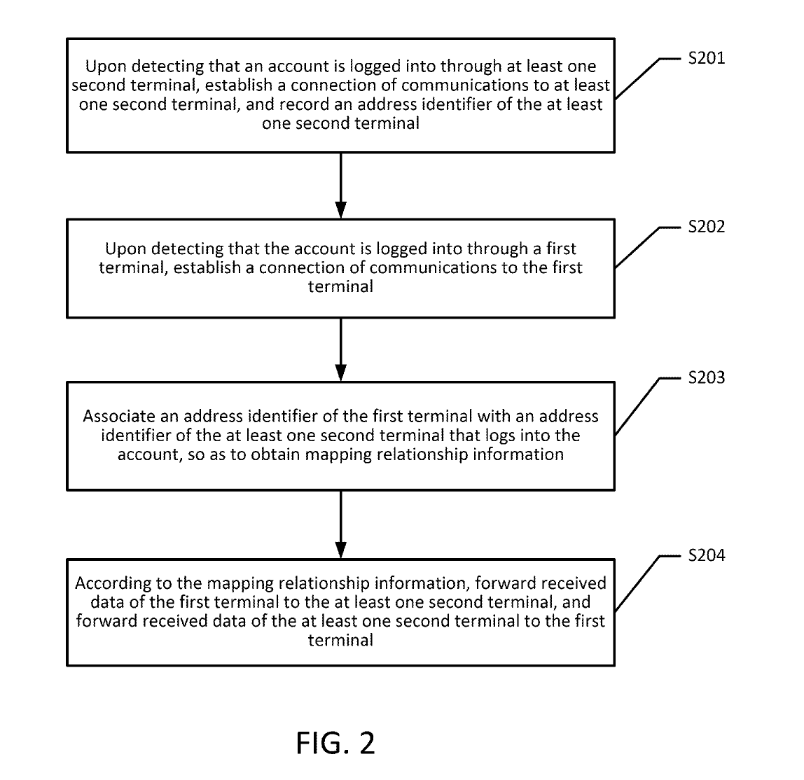

Referring to FIG. 2, a schematic flow chart of a method for data sharing in an SNS is shown according to another embodiment of the present invention. The method of this embodiment can be applied in various SNS application servers. With an account obtained by applying, a user may perform data sharing between devices of the user, such as a PC and a mobile terminal, according to the account. Specifically, the method of this embodiment includes the following steps.

Step S201: Upon detecting that an account is logged into through at least one second terminal, establish a connection of communications to at least one second terminal, and record an address identifier of the at least one second terminal. After the account logs into a server through a corresponding second terminal, the establishing a connection of communications to each second terminal that logs into the account includes: establishing a long connection to at least one second terminal that logs into the account.

Step S202: Upon detecting that the account is logged into through a first terminal, establish a connection of communications to the first terminal, where the establishing the connection of communications to the first terminal that logs into the account includes establishing a long connection to the first terminal that logs into the account.

Step S203: Associate an address identifier of the first terminal with an address identifier of at least one second terminal that logs into the account, so as to obtain mapping relationship information. Specifically, the address identifier of the first terminal and address identifiers of all the second terminals can be stored in a file directory related to the account or in a mapping table, so that the server can search for a corresponding address anytime.

Step S204: According to the mapping relationship information, forward received data of the first terminal to the at least one second terminal, and forward received data of the at least one second terminal to the first terminal.

When the user sends data through the communication application on the first terminal, corresponding account information and the address identifier of the first terminal can be carried to be sent to the server, and the server may first find the corresponding account according to the account information, and then send the data to all the second terminals according to the mapping relationship information and according to the other address identifiers except the address identifier carried in the data. Similarly, when any terminal among all the second terminals sends data, the account and the address identifier are also carried, so that the server forwards the data of the terminal to all the other terminals including the first terminal.

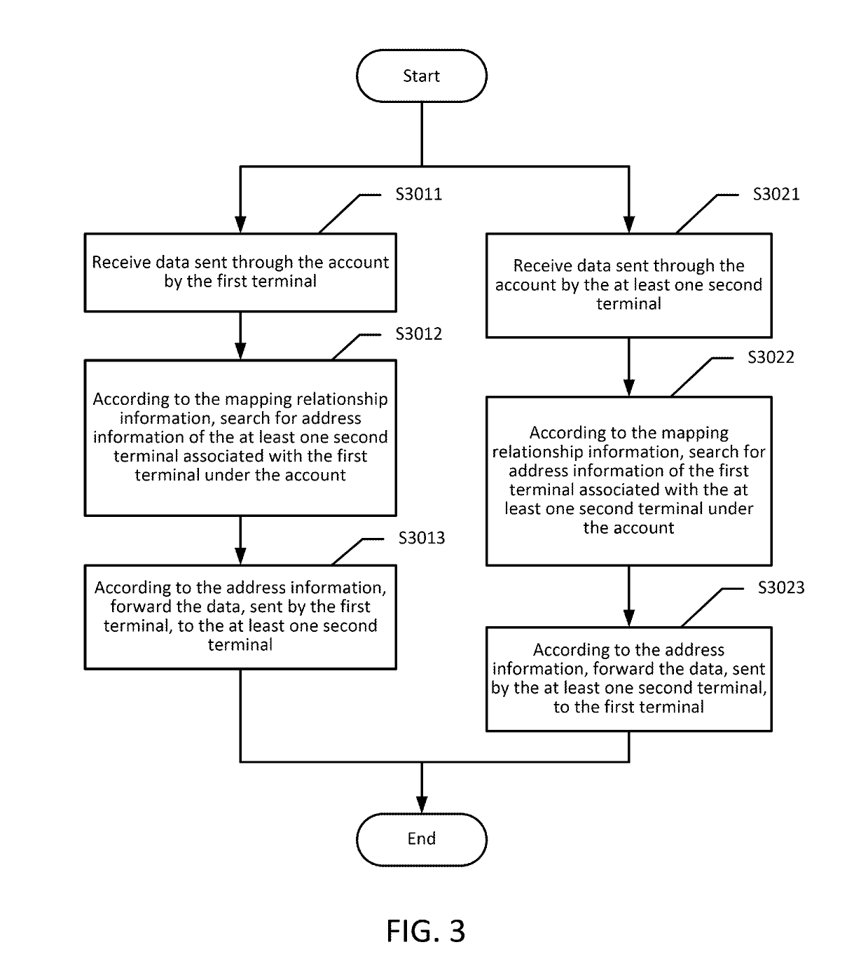

FIG. 3 shows a schematic flow chart of a first embodiment of a data forwarding method of the present invention. The data forwarding method is a specific realization method of Step S103 or Step S204 of the aforementioned embodiments. In this embodiment, the data forwarding method includes the following steps.

Step S3011: Receive data sent through the account by the first terminal.

Step S3012: According to the mapping relationship information, search for address information of at least one second terminal associated with the first terminal under the account.

Step S3013: According to the address information, forward the data, sent by the first terminal, to at least one second terminal.

Step S3021: Receive data sent through the account by the at least one second terminal.

Step S3022: According to the mapping relationship information, search for address information of the first terminal associated with the at least one second terminal under the account.

Step S3023: According to the address information, forward the data, sent by the at least one second terminal, to the first terminal.

The data can be common communications data, for example, data such as a photo and a link address of a website. A mobile terminal acting as the first terminal sends the data to a terminal such as a PC, so as to view the photo and view the website corresponding to the link address by making use of advantages of the PC such as quickness of network surfing and a big screen. The data may also be information such as a phone number and a residence address. A terminal such as a PC that acts as the first terminal may send the data to a mobile terminal such as a mobile phone and a tablet computer, so as to make use of portable performance of the mobile terminal to view corresponding phone numbers and residence addresses anytime when needed to find some friends and users.

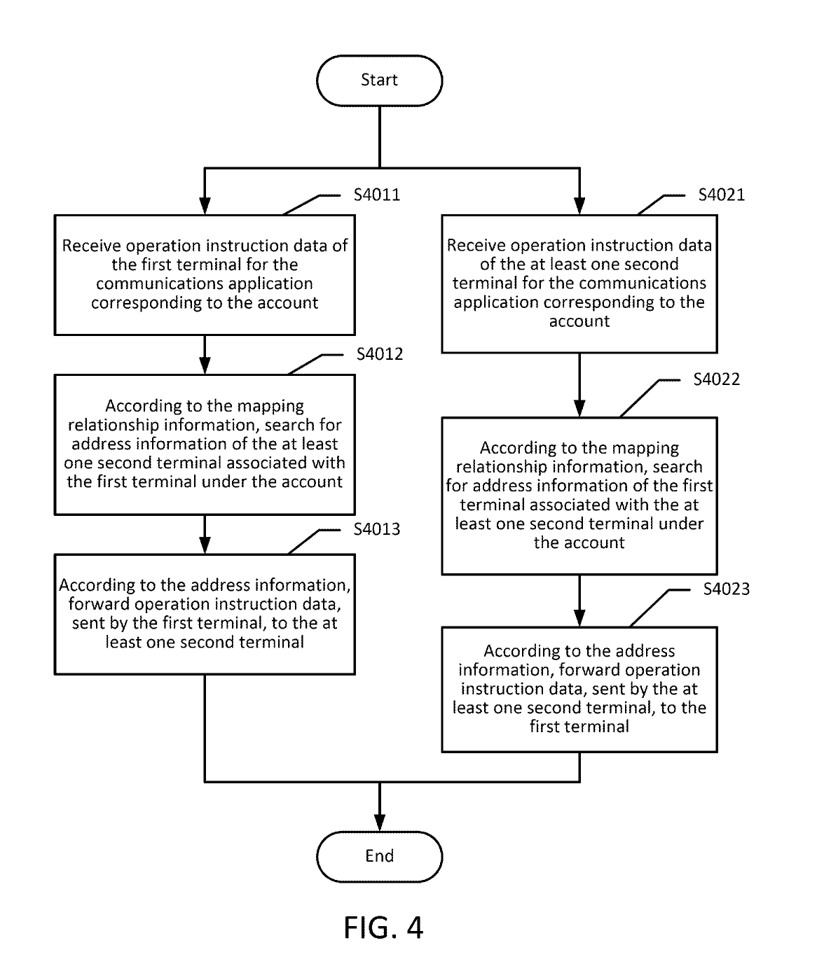

FIG. 4 shows a schematic flow chart of a second embodiment of a data forwarding method of the present invention. The data forwarding method is a specific realization method of Step S103 or Step S204 of the aforementioned embodiments. In this exemplary embodiment, the data forwarding method includes the following steps.

Step S4011: Receive operation instruction data of the first terminal for the communication application corresponding to the account.

Step S4012: According to the mapping relationship information, search for address information of at least one second terminal associated with the first terminal under the account.

Step S4013: According to the address information, forward operation instruction data, sent by the first terminal, to at least one second terminal, so that the at least one second terminal performs a synchronous operation on the communication application corresponding to the account according to the operation instruction data.

Step S4021: Receive operation instruction data of the at least one second terminal for the communication application corresponding to the account.

Step S4022: According to the mapping relationship information, search for address information of the first terminal associated with the at least one second terminal under the account.

Step S4023: According to the address information, forward operation instruction data, sent by the at least one second terminal, to the first terminal, so that the first terminal performs a synchronous operation on the communication application corresponding to the account according to the operation instruction data.

The operation instruction data specifically includes operations such as add, delete, view, and modify, which are performed on a communication application program, so as to make use of portable performance of a mobile terminal such as a mobile phone to remotely control a PC, or make use of the big screen and ease of operation of a PC to control an application of a mobile terminal.

According to the embodiment of the present invention, data sharing between different terminal devices can be realized according to an account, no data line or manual operation of a user is needed, a function of the communication application is added, and the user may use corresponding data by reasonably making use of advantages of different terminals, or perform a corresponding synchronous operation according to operation instruction data.

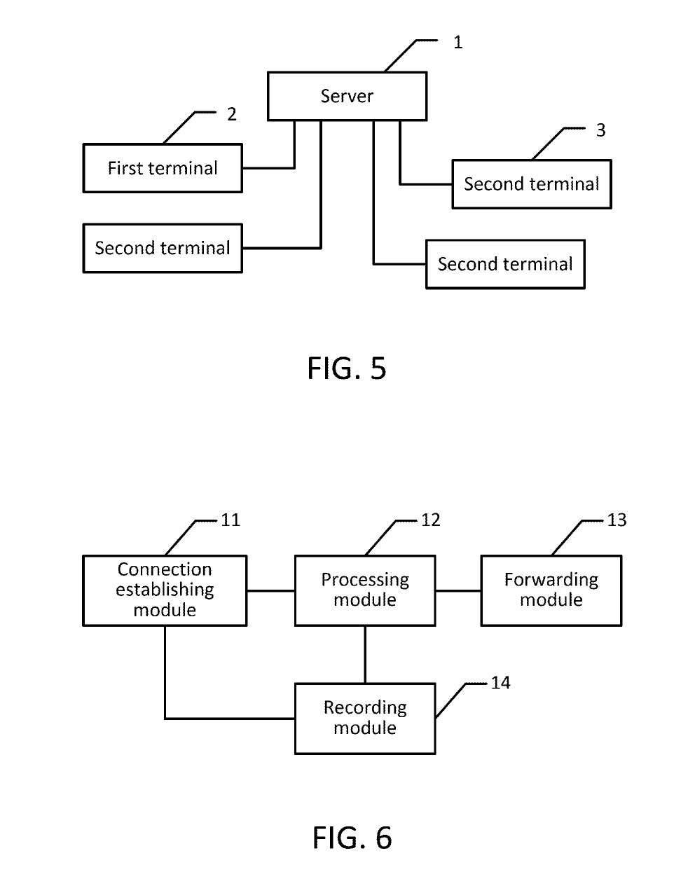

Referring to FIG. 5 a schematic structural diagram of a system for data sharing in an SNS is shown according to one embodiment of the present invention. In the exemplary embodiment, the system includes: a communication application realizing server 1, a first terminal 2, and at least one second terminal. Illustration is provided in details through a second terminal 3. The communication application realizing server 1 can be a server of any SNS application. The first terminal 2 and the second terminal 3 can be terminal devices such as, but not limited to, mobile terminals and PCs.

The first terminal 2 is configured to log into the server 1 through an account.

The server 1 is configured to upon detecting that the account is logged into through the first terminal 2, establish a connection of communications to the first terminal 2, and is configured to when the account is currently logged into from multiple points, associate an address identifier of the first terminal 2 with an address identifier of the second terminal 3 logging into the account, so as to obtain mapping relationship information.

The first terminal 2 is further configured to send data to the server 1, where the data includes communications data or operation instruction data for the communication application which is sent through the server 1 to the second terminal 3.

The second terminal 3 is configured to send data to the server 1, where the data includes communications data or operation instruction data for the communication application which is sent through the server 1 to the first terminal 2.

The server 1 is further configured to according to the mapping relationship information, forward received data of the first terminal 2 to the second terminal 3, and forward received data of the second terminal 3 to the first terminal 2.

The first terminal 2 and the second terminal 3 are mobile terminals, such as mobile phones and tablet computers, or fixed terminals such as PCs, which are installed with a corresponding communication application.

In operation, a user opens the communication application on the first terminal 2, and logs into the server 1 according to an account that is already applied for. After account authentication succeeds, the server 1 accesses the first terminal 2, and the user logs in successfully. The server 1 may establish the connection of communications to the first terminal 2, which is a long connection, so as to perform data sharing anytime.

The server 1 searches for information of all other terminals, which currently already log into the account, according to the account. If at least one other terminal, that is, at least one second terminal 3 is further included besides the first terminal 2, it indicates that a current login status of the account is a multiple-points-of-presence status.

Associating the address identifier of the first terminal 2 with the address identifiers of all the second terminals 3 may specifically be that a mapping table with the account being a topic identifier stores the address identifier of the first terminal 2 and the address identifiers of all the second terminals, so as to obtain the mapping relationship information, where the address identifier can be a phone number of a mobile terminal such as a mobile phone and an IP address of a terminal such as a PC.

When the user sends data through the communication application on the first terminal 2, corresponding account information and the address identifier of the first terminal 2 can be carried to be sent to the server, and the server 1 may first find the corresponding account according to the account information, and then send the data to all the second terminals according to the mapping relationship information and according to the other address identifiers except the address identifier carried in the data. Similarly, when the second terminal 3 sends data, the account and the address identifier of the second terminal 3 are also carried, so that the server 1 forwards the data of the terminal to all the other terminals including the first terminal 2.

According to the embodiment of the present invention, data sharing between different terminal devices can be realized according to an account, no data line or manual operation of a user is needed, a function of the communication application is added, and the user may perform operation according to corresponding data by reasonably making use of advantages of different terminals.

Referring to FIG. 6, a schematic structural view of a server is shown according to one embodiment of the present invention. The server can be the server 1 in the aforementioned embodiment of the system. In the exemplary embodiment, the server include a connection establishing module 11, configured to, upon detecting that an account is logged into through a first terminal, establish a connection of communications to the first terminal; a processing module 12, configured to, if the account is currently logged into from multiple points, associate an address identifier of the first terminal with an address identifier of at least one second terminal logging into the account, so as to obtain mapping relationship information; and a forwarding module 13, configured to, according to the mapping relationship information, forward received data of the first terminal to the at least one second terminal, and forward received data of the at least one second terminal to the first terminal.

In use, a user opens the communication application on the first terminal, and logs into the server according to an account that is already applied for. After account authentication succeeds, the server accesses the first terminal, and the user logs in successfully. The server may establish the connection of communications to the first terminal, which is a long connection, through the connection establishing module 11, so as to perform data sharing anytime.

The server determines, through the processing module 12, whether the account is logged into from multiple points. Specifically, information of all other terminals, which currently already log into the account, is searched for according to the account. If at least one other terminal, that is, at least one second terminal is further included besides the first terminal, it indicates that a current login status of the account is a multiple-points-of-presence status.

The processing module 12 associates the address identifier of the first terminal with the address identifiers of all the second terminals, which may specifically be that a mapping table with the account being a topic identifier stores the address identifier of the first terminal and the address identifiers of all the second terminals, so as to obtain the mapping relationship information, where the address identifier can be a phone number of a mobile terminal such as a mobile phone and an IP address of a terminal such as a PC.

When the user sends data through the communication application on the first terminal, corresponding account information and the address identifier of the first terminal can be carried to be sent to the server, and the server, through the forwarding module 13, may first find the corresponding account according to the account information, and then send the data to all the second terminals according to the mapping relationship information and according to the other address identifiers except the address identifier carried in the data. Similarly, when the second terminal sends data, the account and the address identifier of the second terminal are also carried, so that the server, through the forwarding module 13, forwards the data of the terminal to all the other terminals including the first terminal.

Further, optionally, referring to FIG. 6, the server further includes a recording module 14.

The connection establishing module 11 is further configured to upon detecting that the account is logged into through at least one second terminal, establish a connection of communications to at least one second terminal.

The recording module 14 is configured to record the address identifier of the at least one second terminal.

The recording module 14 records the address identifier of the second terminal, so that the processing module 12 generates and obtains the corresponding mapping relationship information.

Further, the connection establishing module 11 is specifically configured to establish long connections to the first terminal and the at least one second terminal, so as to perform data sharing between the first terminal and the second terminal anytime.

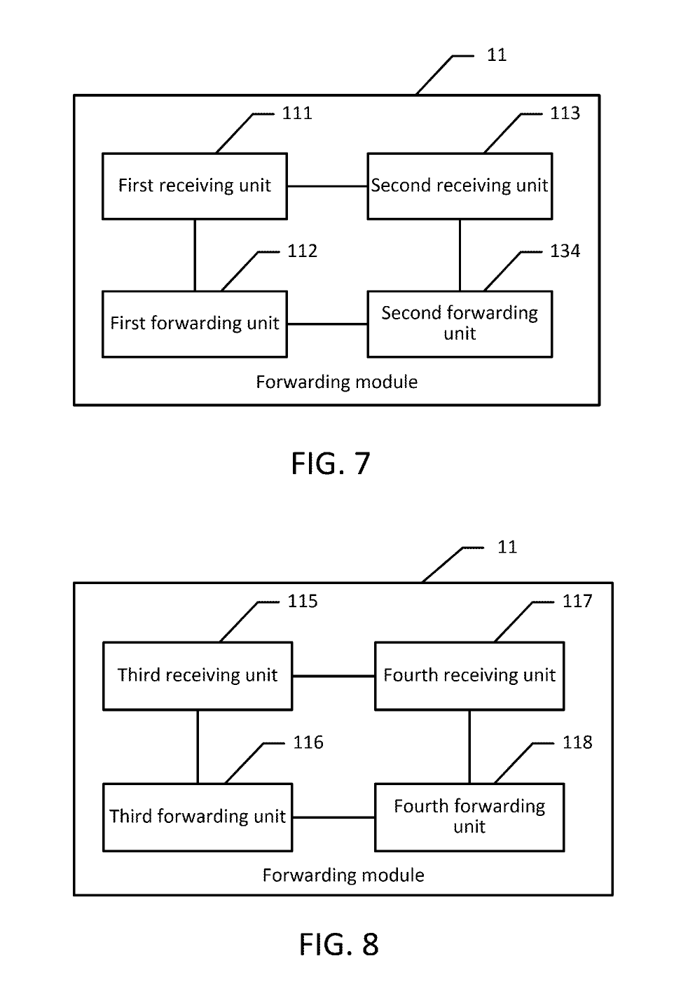

Specifically, FIG. 7 is a schematic view of a specific structure of the forwarding module 13 of the server shown in FIG. 6. The forwarding module 13 includes a first receiving unit 131, configured to receive data sent through the account by the first terminal; a first forwarding unit 132, configured to, according to the mapping relationship information, search for address information of at least one second terminal associated with the first terminal under the account, and according to the address information, send the data, received by the first receiving unit 131, to at least one second terminal; a second receiving unit 133, configured to receive data sent through the account by the at least one second terminal; and a second forwarding unit 134, configured to, according to the mapping relationship information, search for address information of the first terminal associated with the at least one second terminal under the account, and according to the address information, send the data, received by the second receiving unit 133, to the first terminal.

The aforementioned data can be common communications data, for example, data such as a photo and a link address of a website. A mobile terminal acting as the first terminal sends the data to a terminal such as a PC, so as to view the photo and view the website corresponding to the link address by making use of advantages of the PC such as quickness of network surfing and a big screen. The data may also be information such as a phone number and a residence address. A terminal such as a PC that acts as the first terminal may send the data to a mobile terminal such as a mobile phone and a tablet computer, so as to make use of portable performance of the mobile terminal to view corresponding phone numbers and residence addresses anytime when needed to find some friends and users.

FIG. 8 is a schematic view of another specific structure of the forwarding module of the server of FIG. 6. The forwarding module 13 in this embodiment includes a third receiving unit 135, configured to receive operation instruction data of the first terminal for the communication application corresponding to the account; a third forwarding unit 136, configured to, according to the mapping relationship information, search for address information of at least one second terminal associated with the first terminal under the account, and according to the address information, send the operation instruction data, received by the third receiving unit 135, to at least one second terminal, so that the at least one second terminal performs a synchronous operation on the communication application corresponding to the account according to the operation instruction data; a fourth receiving unit 137, configured to receive operation instruction data of the at least one second terminal for the communication application corresponding to the account; and a fourth forwarding unit 138, configured to, according to the mapping relationship information, search for address information of the first terminal associated with the at least one second terminal under the account, and according to the address information, send the operation instruction data, received by the fourth receiving unit 137, to the first terminal, so that the first terminal performs a synchronous operation on the communication application corresponding to the account according to the operation instruction data.

The aforementioned operation instruction data specifically includes operations such as add, delete, view, and modify, which are performed on a communication application program, so as to make use of portable performance of a mobile terminal such as a mobile phone to remotely control a PC, or make use of the big screen and ease of operation of a PC to control an application of a mobile terminal.

Further, the forwarding module in the server 1 may include the structures of the forwarding module shown in FIG. 7 and FIG. 8 at the same time, so as to forward both common data and operation instruction data; further, a first receiving unit 111, a second receiving unit 113, a third receiving unit 115, and a fourth receiving unit 117 therein can be implemented through a receiving unit, and a first forwarding unit 112, a second forwarding unit 114, a third forwarding unit 116, and a fourth forwarding unit 118 can be implemented through one or more forwarding units.

According to the embodiment of the present invention, data sharing between different terminal devices can be realized according to an account, no data line or manual operation of a user is needed, a function of the communication application is added, and the user may use corresponding data by reasonably making use of advantages of different terminals, or perform a corresponding synchronous operation according to operation instruction data.

It should be noted that all or a part of the steps according to the embodiments of the present invention is implemented by hardware or a program instructing relevant hardware. Yet another aspect of the invention provides a non-transitory computer readable storage medium which stores computer executable instructions or program codes. The computer executable instructions or program codes enable a computer or a similar computing apparatus to complete various operations in the above disclosed method for data sharing in an SNS. The storage medium includes, but not limited to, a magnetic disk, an optical disk, a read-only memory (ROM), a random access memory (RAM), random memory (RAM), flash dive, or the likes.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for data sharing in a social networking service (SNS), comprising:
upon detecting that an account is logged into through a first terminal, establishing a connection of communications to the first terminal;
if the account is currently logged into from multiple points, associating an address identifier of the first terminal with an address identifier of at least one second terminal logging into the account, so as to obtain mapping relationship information; and
according to the mapping relationship information, forwarding received data of the first terminal to the at least one second terminal, and forwarding received data of the at least one second terminal to the first terminal.

2. The method according to claim 1, wherein before the step of upon detecting that the account is logged into through the first terminal, establishing the connection of communications to the first terminal, the method further comprises:
upon detecting that the account is logged into through the at least one second terminal, establishing a connection of communications to the at least one second terminal, and recording the address identifier of the at least one second terminal.

3. The method according to claim 2, wherein
the step of establishing the connection of communications to the first terminal comprises establishing a long connection to the first terminal that logs into the account; and
the step of establishing the connection of communications to the at least one second terminal comprises establishing a long connection to the at least one second terminal that logs into the account.

4. The method according to any one of claim 1, wherein the step of according to the mapping relationship information, forwarding the received data of the first terminal to the at least one second terminal, and forwarding the received data of the at least one second terminal to the first terminal comprises:
upon receiving the data sent through the account by the first terminal, searching, according to the mapping relationship information, for address information of the at least one second terminal associated with the first terminal under the account, and forwarding, according to the address information, the data, sent by the first terminal, to the at least one second terminal; and
upon receiving the data sent through the account by the at least one second terminal, searching, according to the mapping relationship information, for address information of the first terminal associated with the at least one second terminal under the account, and forwarding, according to the address information, the data, sent by the at least one second terminal, to the first terminal.

5. The method according to any one of claim 1, wherein the step of according to the mapping relationship information, forwarding the received data of the first terminal to the at least one second terminal, and forwarding the received data of the at least one second terminal to the first terminal comprises:
upon receiving operation instruction data of the first terminal for a communication application corresponding to the account, searching, according to the mapping relationship information, for address information of the at least one second terminal associated with the first terminal under the account, and forwarding, according to the address information, the operation instruction data, sent by the first terminal, to the at least one second terminal, so that the at least one second terminal performs a synchronous operation on the communication application corresponding to the account according to the operation instruction data; and
upon receiving operation instruction data of the at least one second terminal for the communication application corresponding to the account, searching, according to the mapping relationship information, for address information of the first terminal associated with the at least one second terminal under the account, and forwarding, according to the address information, the operation instruction data, sent by the at least one second terminal, to the first terminal, so that the first terminal performs a synchronous operation on the communication application corresponding to the account according to the operation instruction data.

6. The method according to claim 3, wherein the account comprises an account of an SNS application.

7. A server for data sharing, comprising:
a connection establishing module, configured to, upon detecting that an account is logged into through a first terminal, establish a connection of communications to the first terminal;
a processing module, configured to, if the account is currently logged into from multiple points, associate an address identifier of the first terminal with an address identifier of at least one second terminal logging into the account, so as to obtain mapping relationship information; and
a forwarding module, configured to, according to the mapping relationship information, forward received data of the first terminal to the at least one second terminal, and forward received data of the at least one second terminal to the first terminal.

8. The server according to claim 7, further comprising a recording module, wherein:
the connection establishing module is further configured to upon detecting that the account is logged into through the at least one second terminal, establish a connection of communications to the at least one second terminal; and
the recording module is configured to record the address identifier of the at least one second terminal.

9. The server according to claim 8, wherein
the connection establishing module is specifically configured to establish long connections to the first terminal and the at least one second terminal.

10. The server according to any one of claim 7, wherein the forwarding module comprises:
a first receiving unit, configured to receive data sent through the account by the first terminal;
a first forwarding unit, configured to, according to the mapping relationship information, search for address information of the at least one second terminal associated with the first terminal under the account, and according to the address information, send the data, received by the first receiving unit, to the at least one second terminal;
a second receiving unit, configured to receive data sent through the account by the at least one second terminal; and
a second forwarding unit, configured to, according to the mapping relationship information, search for address information of the first terminal associated with the at least one second terminal under the account, and according to the address information, send the data, received by the second receiving unit, to the first terminal.

11. The server according to any one of claim 7, wherein the forwarding module comprises:
a third receiving unit, configured to receive operation instruction data of the first terminal for a communication application corresponding to the account;
a third forwarding unit, configured to, according to the mapping relationship information, search for address information of the at least one second terminal associated with the first terminal under the account, and according to the address information, send the operation instruction data, received by the third receiving unit, to at least one second terminal, so that the at least one second terminal performs a synchronous operation on the communication application corresponding to the account according to the operation instruction data;
a fourth receiving unit, configured to receive operation instruction data of the at least one second terminal for the communication application corresponding to the account; and
a fourth forwarding unit, configured to, according to the mapping relationship information, search for address information of the first terminal associated with the at least one second terminal under the account, and according to the address information, send the operation instruction data, received by the fourth receiving unit, to the first terminal, so that the first terminal performs a synchronous operation on the communication application corresponding to the account according to the operation instruction data.

12. A system for data sharing in a social networking service (SNS), comprising a server, a first terminal, and at least one second terminal, wherein,
the first terminal is configured to log into the server through an account;
the server is configured to, upon detecting that the account is logged into through the first terminal, establish a connection of communications to the first terminal, and when the account is currently logged into from multiple points, associate an address identifier of the first terminal with an address identifier of the at least one second terminal logging into the account, so as to obtain mapping relationship information;
the first terminal is further configured to send data to the server, wherein the data comprises communications data or operation instruction data for the communication application which is sent through the server to the at least one second terminal;
the at least one second terminal is configured to send data to the server, wherein the data comprises communications data or operation instruction data for the communication application which is sent through the server to the first terminal; and
the server is further configured to according to the mapping relationship information, forward received data of the first terminal to the at least one second terminal, and forward received data of the at least one second terminal to the first terminal.

13. The system according to claim 12, wherein the server comprises an SNS application server.

14. A non-transitory computer-readable medium storing instructions which, when executed by one or more processors, cause a system to perform a method for data sharing in a social networking service (SNS), the method comprising:
upon detecting that an account is logged into through a first terminal, establishing a connection of communications to the first terminal;
if the account is currently logged into from multiple points, associating an address identifier of the first terminal with an address identifier of at least one second terminal logging into the account, so as to obtain mapping relationship information; and
according to the mapping relationship information, forwarding received data of the first terminal to the at least one second terminal, and forwarding received data of the at least one second terminal to the first terminal.

15. The non-transitory computer-readable medium according to claim 14, wherein before the step of upon detecting that the account is logged into through the first terminal, establishing the connection of communications to the first terminal, the method further comprises:
upon detecting that the account is logged into through the at least one second terminal, establishing a connection of communications to the at least one second terminal, and recording the address identifier of the at least one second terminal.

16. The non-transitory computer-readable medium according to claim 15, wherein
the step of establishing the connection of communications to the first terminal comprises establishing a long connection to the first terminal that logs into the account; and
the step of establishing the connection of communications to the at least one second terminal comprises establishing a long connection to the at least one second terminal that logs into the account.

17. The non-transitory computer-readable medium according to any one of claim 14, wherein the step of according to the mapping relationship information, forwarding the received data of the first terminal to the at least one second terminal, and forwarding the received data of the at least one second terminal to the first terminal comprises:
upon receiving the data sent through the account by the first terminal, searching, according to the mapping relationship information, for address information of the at least one second terminal associated with the first terminal under the account, and forwarding, according to the address information, the data, sent by the first terminal, to the at least one second terminal; and
upon receiving the data sent through the account by the at least one second terminal, searching, according to the mapping relationship information, for address information of the first terminal associated with the at least one second terminal under the account, and forwarding, according to the address information, the data, sent by the at least one second terminal, to the first terminal.

18. The non-transitory computer-readable medium according to any one of claim 14, wherein the step of according to the mapping relationship information, forwarding the received data of the first terminal to the at least one second terminal, and forwarding the received data of the at least one second terminal to the first terminal comprises:
upon receiving operation instruction data of the first terminal for a communication application corresponding to the account, searching, according to the mapping relationship information, for address information of the at least one second terminal associated with the first terminal under the account, and forwarding, according to the address information, the operation instruction data, sent by the first terminal, to the at least one second terminal, so that the at least one second terminal performs a synchronous operation on the communication application corresponding to the account according to the operation instruction data; and
upon receiving operation instruction data of the at least one second terminal for the communication application corresponding to the account, searching, according to the mapping relationship information, for address information of the first terminal associated with the at least one second terminal under the account, and forwarding, according to the address information, the operation instruction data, sent by the at least one second terminal, to the first terminal, so that the first terminal performs a synchronous operation on the communication application corresponding to the account according to the operation instruction data.

19. The non-transitory computer-readable medium according to claim 16, wherein the account comprises an account of an SNS application.
